(19) United States
(12) Patent Application Publication
(10) Pub. No.: US 2020/0345048 A1
(43) Pub. Date: Nov. 5, 2020

(54) FLAVOUR COMPOSITIONS

(71) Applicant: Givaudan SA, Vernier (CH)

(72) Inventor: Moises GALANO, Sao Paulo (BR)

(21) Appl. No.: 16/758,969

(22) PCT Filed: Nov. 12, 2018
(86) PCT No.: PCT/EP2018/080904

§ 371 Date: Apr. 24, 2020

(30) Foreign Application Priority Data
Nov. 13, 2017 (GB) 17187311

(51) Int. Cl. A23L 27/22; A23L 27/00; A23L 33/175

(52) U.S. Cl. CPC A23L 27/22; A23L 33/175; A23L 27/88

(57) ABSTRACT

A flavour composition is provided. The composition includes a characterizing flavour and a taste modifying composition. The taste modifying composition includes at least four non-polar amino acids and at least one polar amino acid. The at least four non-polar amino acids are present in equal molar concentrations.

### FIELD OF THE INVENTION

The present disclosure relates to flavour compositions suitable for use in a wide variety of consumables. More particularly, the present disclosure relates to flavour compositions useful in delivering improved organoleptic properties to consumables, including modifying sweetness, saltiness, umami and/or mouthfeel.

### BACKGROUND OF THE INVENTION

The flavour of consumables consists of two parts: the aroma and the taste. In general what is perceived through the olfactory epithelium in the nasal cavity is referred to as ‘aroma’, whereas the term ‘taste’ is generally used to describe the sensory impact that is perceived via the mouth, especially the tongue. The flavour sensation experienced upon consumption, especially taste, provides the final analysis of food prior to ingestion thereof. Visual and olfactory (smell) signals already give a first indication but only after intake of the food into the mouth the final decision is made either to ingest or to reject the food. Sweet taste is usually a signal that the food is safe (appetizing) leading to ingestion of the food. The ‘reactions’ to salt and umami are really dependent on the strength of the signal. Bitter and sour are usually repulsive taste sensations, leading to rejection. Temperature is another measure by which the food is judged just as well as aching sensations like capsaicin (hot pepper) and certain chemicals (like carbon dioxide). In short, this means that taste is a very important and very complex system.

Salt and sugar are widely used as a basic flavour modifier for seasoning consumables. However, excessive salt and/or sugar intake is known to have adverse health effects. As a result, commercial products have been developed such as salt substitutes, sugar substitutes, low-salt or low-sugar modifiers and processed consumables with low-salt or low-sugar. A problem of such products, however, is the lack of good taste, for example, a plain taste or disrupted taste balance.

As such, there is a need for new taste modifying compositions having a positive contribution to the flavour, especially taste, of consumables they are incorporated in. One objective of the present invention is the provision of taste modifying compositions for achieving sufficient saltiness or sweetness even in cases where the salt content or sugar content in consumables is reduced.

### SUMMARY OF THE INVENTION

In one embodiment, a flavour composition includes a characterizing flavour; and a taste modifying composition including at least four non-polar amino acids and at least one polar amino acid. The at least four non-polar amino acids are present in equal molar concentrations.

In another embodiment, a savoury consumable includes a flavour composition including a characterizing flavour; and a taste modifying composition including at least four non-polar amino acids and at least one polar amino acid. The at least four non-polar amino acids are present in equal molar concentrations.

These and other features, aspects and advantages of specific embodiments will become evident to those skilled in the art from a reading of the present disclosure.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure is based on the surprising discovery that a combination of a characterizing flavour and a taste modifying composition, incorporated into consumables could improve or amplify the taste perception and aroma profile and deliver sufficient saltiness or sweetness in cases where the salt content or sugar content is reduced. In particular, this combination of non-polar and polar amino acids was found to generate improved or increased perception of saltiness, sweetness and/or umami, which could not be achieved by any other compositions known in the art. Saltiness is a taste sensed when a salty substance such as sodium chloride is introduced into the mouth. Sweetness is a taste sensed when a sweet substance such as sugar, honey, maple syrup, erythritol, trehalose or aspartame is introduced into the mouth. Umami is a taste sensed when a substance such as glutamic acid or inosinic acid is introduced into the mouth similar to savory, brothy or meaty perceptions.

As used herein, the term “taste” is used to describe the sensory response related to taste receptors. The quality of taste may be expressed as the interplay of descriptors. For example, “umami”; “salty”; “potato flavour” associated with the aromatic characteristic of cooked potato; “mouthcoating” associated with the residual linger in the mouth of oily/greasy; and “smoky flavour” associated with the aromatic characteristic of pungent, acrid, ashy or charred/burnt perceptions.

The term “aroma” as used herein is used to describe the effect of volatile components of the flavour composition that induce a sensory response associated with olfactive receptors.

The term “impact” as used herein is used to describe the overall intensity of the sensory response of the “taste” and “aroma” defined herein above.

### Flavour Composition

According to the present disclosure, flavour compositions may include a characterizing flavour; and a taste modifying composition. In one embodiment, the taste modifying compositions include at least four non-polar amino acids; and at least one polar amino acid. The at least four non-polar amino acids are present in equal molar concentrations.

The characterizing flavour and the taste modifying composition should be present in the flavor composition in an organoleptically effective amount. This amount will depend upon the nature of the characterizing flavour and taste modifying composition, as well as the nature of the flavor composition and the effect that is desired to be achieved, and it is within the purview of the skilled person to experiment with the desired amounts.

The flavour compositions of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, savoury products, confectionery products, baked products, sweet products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary savoury products include, but are not limited to, salty snacks (potato chips, crisps, nuts, tortilla-tostada, pretzels, cheese snacks, corn snacks, potato-snacks), ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, mayonnaise, vegan mayonnaise and pasta sauces.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products and beverage and beverage products.

In one embodiment, consumables may be pasteurized. The pasteurization process may include, for example, ultra-high temperature (UHT) treatment and/or high temperature-short time (HTST) treatment. The UHT treatment includes subjecting the consumable to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the consumable is subjected to heating to about 185° F. (85° C.) to about 250° F. (121° C.) for a short period of time, for example, about 1 to 60 seconds, then cooled quickly to about 36° F. (2.2° C.)+/10° F. (5° C.) for refrigerated products, to ambient temperature for shelf stable or refrigerated products, and to about 185° F. (85° C.)+/−10° F. (5° C.) for hot-fill applications for shelf-stable products. The pasteurization process is typically conducted in a closed system, so as not to expose the consumable to atmosphere or other possible sources of contamination. Other pasteurization or sterilization techniques may also be useful, such as, for example, aseptic or retort processing. In addition, multiple pasteurization processes may be carried out in series or parallel, as necessitated by the consumable or ingredients.

In one embodiment, a flavour composition according to the present disclosure may include a characterizing flavor. The term “characterizing flavour” refers to a flavour that is perceived by an individual to be predominant upon consumption by the individual. In one embodiment, the characterizing flavour may be a savory, dairy, sweet or citrus flavour. For example, chicken, beef, pork, ham, barbeque, cheese, milk, vanilla, onion, cocoa, chocolate, orange, lemon, tangerine, grape or mint. Accordingly, an individual may perceive a predominant flavour upon consumption of the composition.

The flavour composition may include the characterizing flavour in an amount from about 0.01 to about 70%, in another embodiment from about 0.01 to about 50%, in yet another embodiment from about 0.01 to about 25%, or any individual number within the range, by weight of the flavour composition. In another embodiment, a consumable may include the characterizing flavour in an amount from about 0.001 to about 0.5%, in another embodiment from about 0.01 to about 0.3%, in yet another embodiment from about 0.02 to about 0.1%, or any individual number within the range, by weight of the consumable.

A flavour composition according to the present disclosure may also include a taste modifying composition. In one embodiment, the taste modifying composition includes non-polar amino acids and polar amino acid(s).

In a typical embodiment, the flavour composition includes from about 0.001% to about 12% of the taste modifying composition, by weight of the flavour composition, and depending upon the particular application desired. In one embodiment, the flavour composition comprise from about 0.1% to about 6% of the taste modifying composition, by weight of the flavour composition. In another embodiment, the flavour composition may comprise from about 0.5% to about 3% or any individual number within the range of the taste modifying composition, by weight of the flavour composition.

In another embodiment, the taste modifying composition may be dosed in a consumable at from about 0.001% to about 1%.

In one embodiment, the taste modifying composition according to the present disclosure may include at least four non-polar amino acids. Suitable non-polar amino acids include, for example, glycine, alanine, valine, proline, leucine, isoleucine, methionine, proline, phenylalanine, and tryptophan. In another embodiment, the taste modifying composition may include at least five non-polar amino acids and in another embodiment at least six non-polar amino acids.

In a typical embodiment, the taste modifying compositions include from about 60% to about 99% of non-polar amino acids, by weight of the taste modifying composition, and depending upon the particular application desired. In one embodiment, the taste modifying compositions comprise from about 65% to about 90% of non-polar amino acids, by weight of the taste modifying composition. In another embodiment, the taste modifying composition may comprise from about 70% to about 80% or any individual number within the range of non-polar amino acids, by weight of the taste modifying composition.

In one embodiment, the non-polar amino acids may be present in equal molar concentrations. In another embodiment, the non-polar amino acids may be present in equal ratios by weight/mass. In another embodiment, the non-polar amino acids may be present in any ratio of non-polar amino acids to one another.

In one embodiment, the taste modifying composition according to the present disclosure may also include at least one polar amino acid selected from the group consisting of tyrosine, serine, threonine, cysteine, glutamine, asparagine, aspartic acid, glutamic acid, lysine, histidine, argenine and mixtures thereof.

In a typical embodiment, the taste modifying compositions include from about 1% to about 40% of the at least one polar amino acid, or any individual number within the range of the at least one polar amino acid, by weight of the taste modifying composition, and depending upon the particular application desired.

The taste modifying compositions may, optionally, include additional ingredients which include, but are not limited to, fillers, flowing agents, carriers, delivery systems, weighting agents, emulsifiers and stabilizers. Suitable fillers include, but are not limited to, flour, rice, maltodextrins, modified starches, gums, cellulose, medium chain triglyceride, alginates, silicon dioxide, whey powder and pectines. When a filler is employed in the flavour composition, it may be used in amounts from 0 to about 99%, by weight of the flavour composition. Suitable free flowing agents or anticaking agents include, but are not limited to, aluminum silicate, calcium aluminum silicate, calcium carbonate, calcium silicate, magnesium carbonate, magnesium silicate, mono-, di- and tri-calcium orthophosphate, potassium aluminum silicate, silicon dioxide (amorphous), sodium aluminum silicate and stearic acid salts. When a free flowing agent or anticaking agent is employed in the flavour composition, it may be used in amounts from 0 to about 10%, by weight of the flavour composition.

A flavour composition according to the present disclosure may be prepared when the characterizing flavour; and a taste modifying composition and any other optional ingredients referred to hereinabove are mixed together to form the flavour composition.

The manner or sequence in which the ingredients are mixed is not particularly important, although when selecting the method in which the essential or optional ingredients are combined, the skilled person will have regard to routine considerations related to supply chain, such as ease and cost of manufacture, storage, transportation and the like. In particular, the skilled person will have regard for any incompatibility that might exist between any of the ingredients, for example, immiscibility of ingredients.

In principle, it is possible that all ingredients may be mixed together extemporaneously to provide the flavour composition according to the present disclosure. However, for the reasons set forth immediately above, extemporaneous preparation may not be advantageous or even desirable.

Flavour compositions may be in the form of emulsions, solutions or dispersions, or in powdered form. For example, it may be desirable or appropriate to add flavour ingredients that are oils, or are oil-soluble to a solution containing all water-soluble ingredients and emulsify the resultant mixture. The flavour composition, in the form of an emulsion could then be further diluted in an aqueous phase, as necessary or appropriate.

Alternatively, it might be desirable or appropriate to mix both oil and oil-soluble ingredients, and water-soluble ingredients with a compatible solvent or solvent system, such as propylene glycol, isopropanol, glycerol, ethanol, water, or mixtures thereof to form a flavour composition in the form of a solution or dispersion, which can then be further diluted in an aqueous phase as necessary or appropriate.

In yet another alternative, the characterizing flavour; and the taste modifying composition including at least four non-polar amino acids; and at least one polar amino acid may be rendered in dry form, and mixed to form a flavour composition in the form of a powder.

In another embodiment, the taste modifying composition according to the present disclosure may be combined with a taste improving substance as described in U.S. Pat. No. 8,778,437, which is herein incorporated by reference for all purposes. In particular, examples of taste improving substances may be selected from the group of N-lactoyl ethanolamine, N-lactoyl ethanolamine phosphate, N-α-hydroxy-butanoyl ethanolamine, N-lactoyl diethanolamine, N-lactoyl-2-amino-1,3-propanediol, N-lactoyl-3-amino-1,2-propanediol, N-lactoyl-3-amino-1-propanol, N-gluconyl-2-amino-1,3-propanediol, N-gluconyl-3-amino-1,2,-propanediol, N-mannonyl ethanolamine, N-glycolyl ethanolamine, 2-hydroxyethyl-N-tartaramide, 2-hydroxyethyl-N-malamide, 2-hydroxyethyl-N-citramide and N-gluconyl alanine.

In one embodiment, the taste modifying composition in combination with a taste improving substance are particularly useful in carbonated beverages and alcoholic beverages. It has been found that this combination is capable of producing a highly desirable perception of tingling with perception of higher carbonation in carbonated beverages. In another example, it has been found that this combination is capable of producing a perception of higher alcohol content, e.g. “alcohol booster”, in alcoholic beverages, including beer. This combination may even be useful in imparting a more bitter sensation to beer which would allow a reduction in the amount of hops used by brewers to achieve the same taste impact.

### EXAMPLES

The following examples are given solely for the purpose of illustration and are not to be construed as limitations of the present invention, as many variations of the invention are possible without departing from the spirit and scope of the present disclosure.

### Example 1—Full Salt Vs. Reduced Salt BBQ Chips

The first flavour composition includes a characterizing flavour and a full salt as control (delivered in 3.5% topical application of seasoning) on an unsalted potato chip (Example A—control). The second flavour composition includes the same characterizing flavour, taste modifying composition and reduced salt (reduced by 26%) (delivered in 3.5% topical application of a barbeque seasoning) (Example B).

TABLE 1

| Ingredients (%) | A (Control) | B |
|---|---|---|
| Characterizing Flavour | 0.65 | 0.65 |
| Barbeque seasoning¹ | | |
| Salt Seasoning | 1.4 | 1.05 |
| Taste Modifying Composition | 0 | 0.006 |

¹Commercial flavour available from Givaudan Flavors Corporation

Examples A and B were prepared as follows. For Example A, (full salt, BBQ flavor without taste modifying composition), 192.91 g of Mike Sell's unsalted potato chips were measured. Next, the chips were microwaved at medium power for 55 seconds, whereupon they were removed and placed in a tumbler apparatus. The tumbler was set to 60% maximum speed. Next, 6.99 g of Barbecue seasoning containing 2.70 g of salt seasoning (1.4% net salt concentration) were added to the chips as evenly as possible, and the tumbler was allowed to continue at 60% speed for 1 minute. The tumbler was turned off, and the chips were removed and stored in vacuum sealed plastic bags prior to sensory evaluation the following day.

For Example B (BBQ flavour+taste modifying composition), 289.30 g of Mike Sell's unsalted potato chips. The chips were heated in a medium power microwave for 55 seconds, added to the tumbler at 60% speed, and finally 10.6 g of Barbeque seasoning containing 0.492 g of taste modifying composition and 3.04 g of salt (1.0% net salt concentration) were added to the chips as evenly as possible, and the tumbler was allowed to continue at 60% speed for 1 minute. The tumbler was turned off, and the chips were removed and stored in vacuum sealed plastic bags prior to sensory evaluation the following day.

### Sensory Results

Key sensory attributes of the samples (A and B) have been assessed by a panel of sensory trained technical panelists tasting blind by comparing the samples A and B in Table 2. Panelists were asked to compare which sample A or B was higher in umami, salty, smoky flavour, potato flavour and mouthcoating perceptions. Samples of Examples A and B were put into individual 2 oz. cups with lids prior to sensory testing and filtered water was available for rinsing between samples. A paired comparison test with 22 participants evaluated Examples A and B. Results in terms of the number of panelists that chose A or B with respect to a particular attribute are shown in Table 2 below

TABLE 2

| | Example A | |
|---|---|---|
| | (salt seasoning + BBQ | Example B |
| Key Sensory | flavour without taste | (BBQ flavour + taste |
| Attribute | modifying composition) | modifying composition) |
| Umami | 7.5 | 14.5 |
| Salty | 11.5 | 10.5 |
| Potato flavour | 12 | 10 |
| Mouthcoating | 4.5 | 17.5 |
| Smoky Flavour | 9 | 13 |

*For panelists that could not make a decision between Examples, their selection was added in 0.5 increments to both Examples.

As shown above, Example B (representative of the invention) performs better in comparison to the full salt control sample. Panelists rated umami, mouthcoating and smokey flavour higher than the control sample and salty nearly identical. Results suggest that taste modifying composition may therefore have enhanced a variety of sensory properties important to the flavour profile of the chip as a whole including the perception of salty, despite a reduction in sodium.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A flavour composition comprising:
a characterizing flavour; and
a taste modifying composition including at least four non-polar amino acids and at least one polar amino acid;
wherein the at least four non-polar amino acids are present in equal molar concentrations.

2. The composition according to claim 1, wherein the at least four non-polar amino acids are selected from the group consisting of glycine, alanine, valine, proline, leucine, isoleucine, methionine, proline, phenylalanine, tryptophan and mixtures thereof.

3. The composition according to claim 1, further comprising at least five non-polar amino acids.

4. The composition according to claim 1, further comprising at least six non-polar amino acids.

5. The composition according to claim 1, wherein the at least one polar amino acid is selected from the group consisting of tyrosine, serine, threonine, cysteine, glutamine, asparagine, aspartic acid, glutamic acid, lysine, histidine, argenine and mixtures thereof.

6. The composition according to claim 1, wherein the at least one polar amino acid is aspartic acid or glutamic acid.

7. The composition according to claim 1, wherein the flavour composition includes from about 0.001% to about 70% by weight of the characterizing flavour.

8. The composition according to claim 1, wherein the flavour composition includes from about 0.1% to about 6% by weight of the taste modifying composition.

9. The composition according to claim 8, wherein the taste modifying composition includes from about 60% to about 99% by weight of the at least four non-polar amino acids.

10. The composition according to claim 8, wherein the taste modifying composition includes from about 1% to about 40% by weight of the at least one polar amino acid.

11. (canceled)

12. (canceled)

13. The composition according to claim 1, wherein the flavour composition is in the form of a powder.

14. A consumable comprising:
a flavour composition including a characterizing flavour; and a taste modifying composition including at least four non-polar amino acids and at least one polar amino acid;
wherein the at least four non-polar amino acids are present in equal molar concentrations.

15. The consumable according to claim 14, wherein the at least four non-polar amino acids are selected from the group consisting of glycine, alanine, valine, proline, leucine, isoleucine, methionine, proline, phenylalanine, tryptophan and mixtures thereof.

16. The consumable according to claim 14, wherein the at least one polar amino acid is selected from the group consisting of tyrosine, serine, threonine, cysteine, glutamine, asparagine, aspartic acid, glutamic acid, lysine, histidine, argenine and mixtures thereof.

17. The consumable according to claim 14, wherein the at least one polar amino acid is aspartic acid or glutamic acid.

18. The consumable according to claim 14, wherein the flavour composition includes from about 0.001% to about 70% by weight of the characterizing flavour.

19. The consumable according to claim 14, wherein the flavour composition includes from about 0.1% to about 6% by weight of the taste modifying composition.

20. The consumable according to claim 19, wherein the taste modifying composition includes from about 60% to about 99% by weight of the at least four non-polar amino acids.

21. The consumable according to claim 19, wherein the taste modifying composition includes from about 1% to about 40% by weight of the at least one polar amino acid.

22. The consumable according to claim 14, wherein the flavor composition comprises at least five non-polar amino acids.
